(19) United States
(12) Patent Application Publication
(10) Pub. No.: US 2011/0235015 A1
(43) Pub. Date: Sep. 29, 2011

(54) ILLUMINATION OPTICS FOR EUV MICROLITHOGRAPHY

(75) Inventors: Guenther Dengel, Heidenheim (DE); Gero Wittich, Aalen (DE); Udo Dinger, Oberkochen (DE); Ralf Stuetzle, Aalen (DE); Martin Endres, Koenigsbronn (DE); Jens Ossmann, Aalen (DE); Berndt Warm, Schwaig (DE)

(73) Assignee: Carl Zeiss GmbH, Oberkochen (DE)

(21) Appl. No.: 13/076,730

(22) Filed: Mar. 31, 2011

Related U.S. Application Data
(63) Continuation of application No. PCT/EP2009/005113, filed on Jul. 14, 2009.
(60) Provisional application No. 61/110,142, filed on Oct. 31, 2008.

(30) Foreign Application Priority Data
Oct. 31, 2008 (DE) 10 2008 043 372.1

(51) Int. Cl. G03B 27/72

(52) U.S. Cl. 355/71

(57) ABSTRACT

An illumination optics for EUV microlithography illuminates an object field with the aid of an EUV used radiation beam. Preset devices preset illumination parameters. An illumination correction device corrects the intensity distribution and/or the angular distribution of the object field illumination. The latter has an optical component to which the used radiation beam is at least partially applied upstream of the object field and which can be driven in a controlled manner. A detector acquires one of the illumination parameters. An evaluation device evaluates the detector data and converts the latter into control signals. At least one actuator displaces the optical component. During exposures, the actuators are controlled with the aid of the detector signals during the period of a projection exposure. A maximum displacement of below 8 μm is ensured for edges of the object field towards an object to be exposed. The result is an illumination optics that is used to ensure conformance with preset illumination parameters even given the most stringent demands upon precision.

### CROSS-REFERENCE TO RELATED APPLICATIONS

This application is a continuation of, and claims benefit under 35 USC 120 to, international application PCT/EP2009/005113, filed Jul. 14, 2009, which claims benefit under 35 USC 119 of German Application No. 10 2008 043 372.1, filed Oct. 31, 2008 and under 35 USC 119(e) of U.S. Ser. No. 61/110,142, filed Oct. 31, 2008. International application PCT/EP2009/005113 is hereby incorporated by reference in its entirety.

### FIELD

The disclosure relates to an illumination optics for EUV microlithography. The disclosure also relates to an illumination system with such an illumination optics and to a projection exposure machine with such an illumination system.

### BACKGROUND

A projection exposure machine for EUV microlithography is known from DE 10 2005 062 038 A1. Illumination correction devices for projection exposure machines are known from U.S. Pat. No. 6,366,341 B1, EP 0 952 491 A2, EP 1 349 009 A2, EP 0 720 055 A1, EP 1 291 721 A1, WO 2007/039 257 A1, WO 2006/066 638 A1 and US 2006/0244941 A1.

### SUMMARY

The present disclosure provides an illumination optics for EUV microlithography so as to ensure conformance with preset illumination parameters even given the most stringent demands upon precision.

According to the disclosure, an illumination optics for EUV microlithography illuminates an object at the location of an object field with the aid of an EUV used radiation beam. The illumination optics includes an illumination intensity preset device and an illumination angle preset device for illuminating the object field with a prescribed intensity distribution and with a prescribed illumination angle distribution within the object field. The illumination optics is also equipped with an illumination correction device for correcting at least one of the following illumination parameters: intensity distribution of the object field illumination; and angular distribution of the object field illumination.

The illumination correction device includes a diaphragm arrangement which is arranged in the region of an object field plane, or of a plane conjugate thereto. The illumination correction device has a plurality of finger diaphragms, which can be displaced along a displacement direction (y) along which the object is displaced during the projection exposure. The illumination correction device also has at least one detector for measuring the position of an EUV used radiation beam in the region of the object field. The detector is connected for signaling purposes to at least one evaluation device for evaluating the detector data and for converting the detector data into control signals. The illumination correction device further includes at least one actuator, which is connected for signaling purposes to the evaluation device, for varying the relative position between the EUV used radiation beam and the diaphragm arrangement.

The illumination correction device is designed in such a way that during the illumination period a maximum displacement of 8 μm is ensured for edges of the used radiation beam towards the finger diaphragms perpendicular to the beam direction of the used radiation beam.

Since the diaphragm arrangement is arranged in the region of an object field plane, or of a plane conjugate thereto, a displacement of the object field also corresponds to a displacement of the used radiation beam. If, moreover, the diaphragm arrangement is arranged in the region of the object field plane, it is possible to determine a change in dose at the location of the object field from a change in position of the relative position between the used radiation beam and diaphragm arrangement. If, by contrast, the diaphragm arrangement is arranged in a plane conjugate to the object field plane, it is also desirable to take account of the object to image ratio between the conjugate plane and the object field plane.

Diaphragm arrangements that control the intensity distribution on the reticle with the aid of measured values that are determined near the wafer are typically installed in exposure systems for wafers. These measurements can be carried out regularly only in exposure pauses, and therefore can reduce the throughput of the exposure systems. It has been realized in accordance with the disclosure that fluctuations in illumination parameters that can be used to characterize the object field illumination are caused by relative movements of the illuminated object field in relation to these diaphragm arrangements during the period in which the object is exposed to projection, and can be measured only by impermissible frequent interruptions to the exposure operations. The maximum permissible movements between the object field and the diaphragm arrangement are determined by a prescribed field width and the desired dose stability. By way of example, a maximum object field movement towards the object of 8 mm*0.1%=8 μm is permissible given a field width of 8 mm, a field with homogeneous intensity and a dose stability, that is to say a stability of the total used radiation incident on the object field, of 0.1 percent. The relative movement may reach at most the value of 8 μm between two measurement operations for the diaphragm arrangement of the exposure units, something which can be effected in the case of high thermal loads on the illumination system only with unacceptably frequent measurement operations, since the calibration operations interrupt the exposure process. The inventive illumination correction device reduces such relative movements without additional measurement operations in the wafer plane to a degree that leads to illumination parameters that satisfy even the most stringent desired properties. The illumination correction device preferably ensures a maximum displacement of below 8 μm of the object field towards the object perpendicular to the beam direction of the used radiation beam. This maximum displacement can be, for example, 5 μm, or else smaller than 5 μm. This stability can be achieved by introducing an additional control loop for the field position that is based on additional sensors and actuators.

An illumination correction device that ensures a maximum displacement of the used light beam towards the finger diaphragms of a diaphragm arrangement serving to influence the illumination parameters of the object field illumination additionally increases the stability of the object field illumination. The illumination correction device preferably ensures a maximum displacement of 8 μm during the projection exposure of the object for edges of the used light beam towards the finger diaphragms. Particularly when use is made of a reticle reflective to EUV light, a relative position of a diaphragm arrangement has—as has been realized according to the disclosure—a particularly strong effect in correcting an intensity distribution of the object field illumination that is arranged near the reticle, since such a diaphragm arrangement can penetrate into the used radiation beam only from one side, and so a displacement of the used radiation beam relative to such a diaphragm arrangement does not lead to a self-compensation of a change in intensity.

The relative position between the used light beam and diaphragm arrangement can be corrected with the aid of a time constant such that the illumination parameter is corrected with the aid of a time constant in the region of 5 ms from the acquisition of an illumination actual value by the detector up to the driven displacement of the actuator, ensures that the correction attains a satisfactory action during the illumination of the object.

A design of the illumination correction device in the form that the actuator effects a displacement at least of one EUV correction mirror and hereby causes the variation in the relative position between the EUV used radiation beam and the diaphragm arrangement permits an efficient correction of the relative positions of the object field in relation to the object and/or of the used radiation beam in relation to the diaphragm arrangement. The correction mirror can be displaced by up to six degrees of freedom through being driven.

At least one adjustment light source, in particular an adjustment laser, in conjunction with a detector for the laser radiation whose adjustment radiation beam is guided on a path that coincides with the path of the used radiation beam or is closely adjacent thereto, the at least one detector of the illumination correction device being designed to be sensitive to the at least one adjustment radiation beam, enables a stabilization of the object field in relation to the object or of the used radiation beam in relation to the diaphragm arrangement without a concomitant loss of used light for the detection of the illumination parameters.

There are corresponding advantages for a detector that is designed to be sensitive to light wavelengths carried with the used radiation beam and which differ from the wavelength of the used radiation beam. These wavelengths can then advantageously be used to detect interference and to optimize the illumination parameters.

Piezo actuators or Lorentz actuators permit a highly precise displacement of the correction mirror. Other types of actuator can also be used. Lorentz actuators are known, for example, from U.S. Pat. No. 7,145,269 B2.

An EUV correction mirror has three actuators that are arranged to be distributed in a circumferential direction and via which the EUV correction mirror can be pivoted about an axis that is perpendicular to its optical surface, particularly permit the rotation of the position of the object field about an axis that is perpendicular to the object plane. This can be used for exacting correction tasks.

A piezo actuator that has a plurality of stacked individual plates made from a piezoelectrically active material leads to an enlargement of the piezoelectrically achievable displacement amplitude.

Two correction mirrors that can be displaced through being driven by at least two degrees of freedom enable a virtually independent correction of an intensity distribution of the object field illumination, on the one hand, and of an angular distribution of the object field illumination, on the other hand.

Both a pupil facet mirror of the illumination optics that serves to preset the illumination angle and an EUV mirror that is arranged downstream of the illumination intensity preset device and of the illumination angle preset device and is arranged upstream of the object field have proved to be particularly suitable as correction mirrors for correcting the illumination parameters.

A detector which measures spatial resolution and acquires at least one section of a measuring light beam, enables a sensitive acquisition of the measuring light beam. The measuring light beam can be at least one portion of the used radiation beam, or else an adjustment laser beam or light also carried with the used light.

The measurement results of two detectors that are both arranged in non-mutually conjugate planes can acquire independent illumination parameters for characterizing the intensity distribution of the object field illumination, on the one hand, and the angular distribution of the object field illumination, on the other hand.

Detection with the aid of at least one detector that is arranged at that end of a finger diaphragm facing the used radiation beam permits an efficient correction of a diaphragm arrangement, having finger diaphragms, for influencing illumination parameters. In a preferred design, the detectors can be of extended design at the ends of the finger diaphragms in such a way that they completely cover the used radiation beam in a state fully inserted into the latter. A complete measurement of the used radiation beam is then possible in this position.

A detector in the form of a field position detector, in particular, which is designed in such a way that it acquires with spatial resolution an edge-side section, transverse (x) to the displacement direction (y), of the used radiation beam (3) along the entire extent of the latter, parallel to the displacement direction (y), permits sensitive determination of the position of the object field illumination on the edge side.

A thermal detector is inexpensive.

The advantages of an illumination system including an illumination optics as described correspond to the previously described advantages of the illumination optics. The common holder on a support frame innately reduces a maximum undesired relative displacement of the object field towards the object or of the used radiation beam towards an optical component of the illumination correction device. The support frame of the illumination system is, in particular, designed such that natural frequencies of the support frame, which could build up in association with the operation of the projection exposure machine, are particularly well damped for vibration.

As an alternative to rigidly fixing the illumination optics and the light source on a common support frame, the light source can also be displaced in relation to the downstream illumination optics by at least two degrees of freedom through being driven. The effect of a displacement of the light source in relation to the downstream illumination optics can then correspond to the effect of the displaceable optical component of the illumination correction device.

A signal connection between the evaluation device and the control device of the light source enables account to be taken of changes in parameters of the light source upon correction of the illumination optics by the illumination correction device. It is hereby possible in particular, to take account of a change, detected via the control device, in the beam direction of the light source, or a change in the total energy or the energy distribution in the used radiation beam.

The advantages of a projection exposure machine including an inventive illumination system correspond to those that have been explained above with reference to the illumination system and the illumination optics.

### BRIEF DESCRIPTION OF THE DRAWINGS

Exemplary embodiments of the disclosure are explained in more detail below with the aid of the drawing, in which:

FIG. 1 shows a schematic in meridional section, in relation to an illumination optics, of a projection exposure machine for microlithography;

FIG. 2 shows a view of a facet arrangement of a field facet mirror of the illumination optics of the projection exposure machine according to FIG. 1;

FIG. 3 shows a view of a facet arrangement of a pupil facet mirror of the illumination optics for the projection exposure machine according to FIG. 1;

FIG. 4 shows an enlarged detail from FIG. 1 in the region of a reticle plane;

FIG. 5 shows a view of a field intensity preset device of the projection exposure machine according to FIG. 1 from the viewing direction V in FIG. 4;

FIG. 6 shows a further design of an illumination optics for the projection exposure machine with adjustment lasers according to FIG. 1, in the meridional section;

FIG. 7 shows a further design of an illumination optics for the projection exposure machine with detectors for light emitted by the source, according to FIG. 1, in the meridional section;

FIG. 8 shows in perspective a mirror of the illumination optics according to FIG. 7 that can be displaced in two angles and height with the aid of actuators;

FIG. 9 shows a further design of a mirror of the illumination optics according to FIG. 7 that can be displaced by actuators in 2 positions and angles of rotation; and

FIG. 10 shows a further design of a field intensity preset device with field position detectors on the edge side.

### DETAILED DESCRIPTION

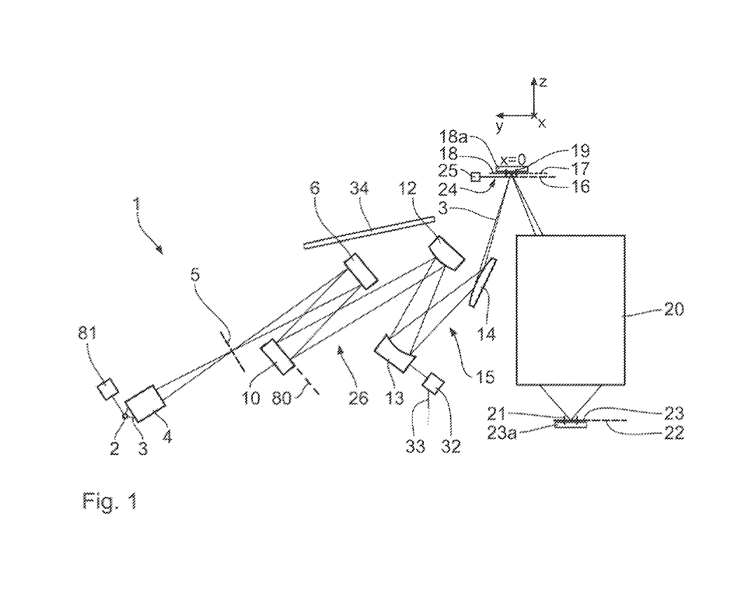

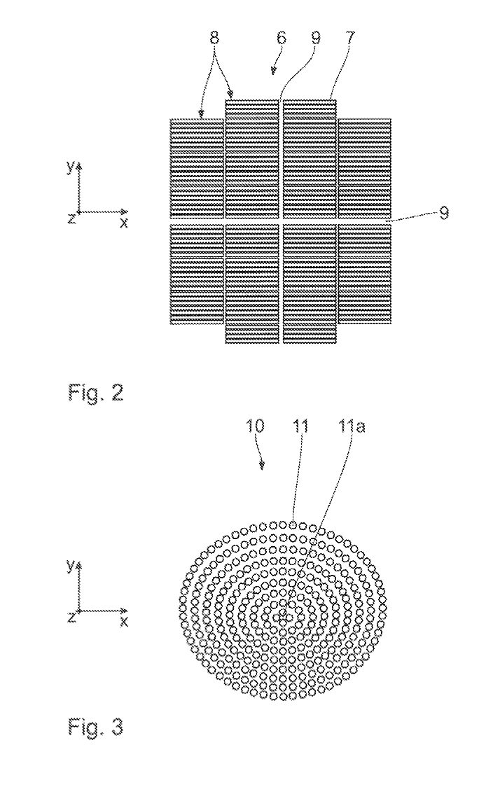

A projection exposure machine 1 for microlithography which is illustrated schematically in FIG. 1, serves to produce a microstructured or nanostructured electronic semiconductor component. A light source 2 emits EUV radiation in a wavelength region between 5 nm and 40 nm, for example, between 5 nm and 30 nm. In the context of EUV radiation, “radiation” and “light” are used synonymously in this application. A used radiation beam or used light beam 3 is used for the purpose of illuminating and imaging inside the projection exposure machine 1. Downstream of the light source 2, the used radiation beam 3 firstly traverses a collector 4 which can, for example, be a nested collector with a multishell design known from the prior art. Downstream of the collector 4, the used radiation beam 3 firstly traverses an intermediate focal plane 5, and this can be used to separate the used radiation beam 3 from undesired radiation components or particle components. After traversing the intermediate focal plane 5, the used radiation beam 3 firstly strikes a field facet mirror 6. A design of the field facet mirror 6 is illustrated in FIG. 2.

In order to facilitate the description of positional relationships, an xyz-coordinate system is respectively depicted in the drawing. In FIG. 1 the x-axis runs perpendicular to the plane of the drawing and into the plane. In FIG. 1, the y-axis runs to the left. In FIG. 1 the z-axis runs upwards.

FIG. 2 shows for example a facet arrangement of field facets 7 of the field facet mirror 6. The field facets 7 are rectangular and respectively have the same x/y aspect ratio. It is also possible to use curved field facets instead of the rectangular field facets 7. The field facets 7 constitute a reflection surface of the field facet mirror 6 and are grouped in the example into four columns each having six field facet groups 8. The field facet groups 8 each have seven field facets 7, as a rule. The two edge-side field facet groups 8 of the two middle field facet columns respectively have four additional field facets 7 so that these field facet groups 8 have a total of eleven field facets 7. Between the two middle facet columns and between the third and fourth facet group rows, the facet arrangement of the facet mirror 6 has interspaces 9 in which the field facet mirror 6 is shaded by holding spokes of the collector 4.

After reflection at the field facet mirror 6, the used radiation beam 3 split up into ray cones that are assigned to the individual field facets 7 strikes a pupil facet mirror 10.

FIG. 3 shows an exemplary facet arrangement of round pupil facets 11 of the pupil facet mirror 10. The pupil facets 11 are arranged around a center 11a in facet rings located one inside the other. Each ray cone of the used radiation beam 3 that is reflected by one of the field facets 7 is assigned a pupil facet 11 so that an affected facet pair with one of the field facets 7 and one of the pupil facets 11 in each case constitutes a beam guidance channel for the associated ray cone of the used radiation beam 3. The channel-wise assignment of the pupil facets 11 to the field facets 7 is performed in dependence on a desired illumination by the projection exposure machine 1. The field facet mirrors 7 are individually tilted about the x-axis, on the one hand, and about the y-axis, on the other hand, in order to drive specific pupil facets 11, i.e. so as to preset specific beam guidance channels.

The field facets 7 are imaged in a field plane 16 of the projection exposure machine 1 via the pupil facet mirror 10 and a downstream transmission optics 15 consisting of three EUV mirrors 12, 13, 14. The EUV mirror 14 is designed as a grazing incidence mirror.

A reticle plane 17 in which a reticle 18 is arranged lies downstream of the field plane 16 and at a spacing of about 5 mm to 20 mm in the z-direction. The reticle 18 is held by a holding device 18a. The used radiation beam 3 is reflected by the reticle 18. The region of the reticle 18 which is illuminated by the used radiation beam 3 is the region that coincides with an object field 19 of a downstream projection optics 20 of the projection exposure machine 1.

Thus, in the projection exposure machine 1 the field plane 16 in which the field facets 7 are imaged in facet images by the transmission optics 15, and the reticle plane 17 which simultaneously constitutes the object plane of the projection optics 20, do not coincide. Alternatively, it is also possible to design the projection exposure machine 1 so that the field plane 16 coincides with the reticle plane 17.

Via the components 4, 6, 10, 12, 13 and 14 that guide and shape the used radiation beam 3, the light source 2 produces an extended illumination with a preset illumination intensity distribution and a preset illumination angle distribution over the object field 19. Optical parameters assigned to the intensity distribution and the angular distribution can be measured next to the reticle 18 with the aid of detectors still to be illustrated below. An adaptation of an actual illumination of the object field 19 to a desired illumination is hereby possible. The radiation reflected and diffracted by the reticle 18 defines the object for the downstream projection optics 20.

The projection optics 20 images the object field 19 in the reticle plane 17 in an image field 21 in an image plane 22. Arranged in this image plane 22 is a wafer 23 that carries a photosensitive layer that is exposed with the aid of the projection exposure machine 1 during a projection exposure. The wafer 23 is held by a holding device 23a. During the projection exposure, the holding devices 18a, 23a both of the reticle 18 and of the wafer 23 are displaced in a synchronized fashion in the y-direction and, in particular, scanned in a synchronized fashion. The projection exposure machine 1 is designed in this case as a scanner. The y-direction is, therefore, also denoted as the scanning direction or as the object displacement direction.

A field intensity preset device 24 is arranged in the field plane 16. The field intensity preset device 24 is, for example, an example of an illumination correction device of the projection exposure machine 1 for correcting an intensity distribution of the illumination of the object field 19. The field intensity preset device 24 serves to set an intensity distribution over the object field 19 that is scan-integrated, that is to say integrated in the y-direction. The field intensity preset device 24 is driven by a control device 25.

The field facet mirror 6, the pupil facet mirror 10, the mirrors 12 to 14 of the transmission optics 15 and the field intensity preset device 24 are components of an illumination optics 26 of the projection exposure machine 1. The field facet mirror 6 constitutes an illumination intensity preset device of the illumination optics 26. The pupil facet mirror 10 constitutes an illumination angle preset device of the illumination optics 26.

In the case where the illumination optics 26 is aligned in relation to the projection optics 20 such that the field plane 16 coincides with the reticle plane 17, the field intensity preset device 24 is not arranged in the field plane 16, but is arranged in front of the field plane by approximately 5 mm to approximately 20 mm. In this case, in addition to a correction of the intensity distribution of the illumination of the object field 19 the field intensity preset device 24 also serves to a certain extent to correct an angular distribution of the object field 19.

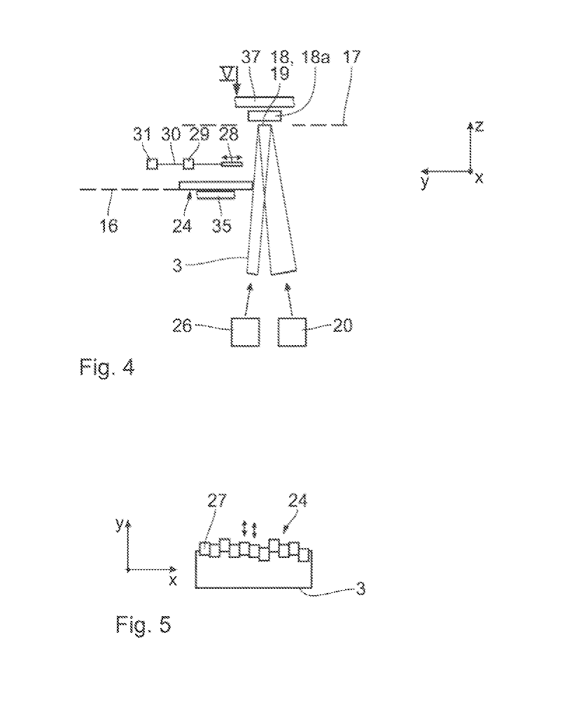

FIGS. 4 and 5 show the field intensity preset device 24 in greater detail. The field intensity preset device 24 has a plurality of finger-like individual diaphragms 27 arranged next to one another. Present in the case of the design, according to FIGS. 4 and 5, are a total of twenty-six individual diaphragms 27 each with a width of 4 mm. Only eleven individual diaphragms 27 of these are illustrated in FIG. 5. The individual diaphragms 27 are directly adjacent to one another and also arranged in a partially overlapping fashion. In the case of a partial overlap, adjacent ones of the individual diaphragms 27 are present in planes that are as closely adjacent to one another as possible and perpendicular to the beam direction of the used radiation beam 3.

All the individual diaphragms 27 are inserted into the used radiation beam 3 from one and the same side. The control device 25 can be used to set the individual diaphragms 27 in a preset position in the y-direction in a fashion independent of one another. Depending on the particular field height, that is to say particular x-position, at which an object point on the reticle 18 passes the object field 19 during the reticle displacement, the scan path of this object point in the y-direction, and thus the integrated used radiation intensity that this object point experiences is determined by the y-position of the respective individual diaphragm 27. It is possible in this way to achieve a homogenization or a preset distribution of the used radiation intensity illuminating the reticle 18 via a presetting of the relative y-positions of the individual diaphragms 27. The field intensity preset device 24 is also termed a “UNICOM” (Uniformity Correction Module) because of its target parameter, that is to say an intensity distribution of the illumination of the object field 19 that is as uniform as possible.

A detector 28 driven via a drive 29 can be inserted into the beam path of the used radiation beam 3 between the field intensity preset device 24 and the reticle 18. The used radiation beam 3 can thus be measured in exposure pauses of the projection exposure machine 1. The detector 28 is a detector which measures with spatial resolution, for example, a CCD chip that has been rendered sensitive to the used radiation beam 3 with the aid of appropriate attachment elements, for example, a scintillation plate.

The detector 28 is connected for signaling purposes to an evaluation device 31 via a signal line 30. The evaluation device 31 serves to evaluate the detector data.

The EUV mirror 13 is connected mechanically to an actuator 32. The actuator 32 can be used to displace the mirror 13 in all six degrees of freedom, that is to say in three degrees of translational freedom and three degrees of tilting freedom. The actuator 32 is connected for signaling purposes to the evaluation device 31 via a signal line 33 that is partially indicated in FIG. 1.

All the rigid elements of the illumination optics 26 are fixed with high precision and securely against thermal and/or mechanical drift on a support frame 34 that is indicated only schematically in FIG. 1. Part of the support frame 34 is also a rigid guide component 35 (compare FIG. 4) along which the individual diaphragms 27 of the field intensity preset device 24 are carried with appropriate precision. As a result of this highly precise guidance, a maximum displacement of the finger diaphragms 27 by at most 8 μm in the y-direction towards the used radiation beam 3 is ensured during a period of an illumination of the reticle 18. This ensures that an intensity distribution of the illumination of the object field 19 set with the aid of the field intensity preset device 24 varies by at most 0.1%.

The reticle 18 is held by the holding device 18a that is indicated in FIG. 4 and is guided in relation to a reticle guiding component 37 during a reticle displacement. The reticle guiding component 37 is likewise part of the support frame 34 and secured with high precision against thermal and mechanical drift.

The precision at which the reticle guiding component 37 is guided is such that a deviation in the reticle actual position from a desired position is at most 2.8 nm during the exposure of the reticle 18.

The support frame 34 is, in particular, designed so that it is decoupled from vibration frequencies which correspond to an exposure period of the reticle 18 so that, therefore, no resonances of the support frame 34 can occur in the range of such natural frequencies.

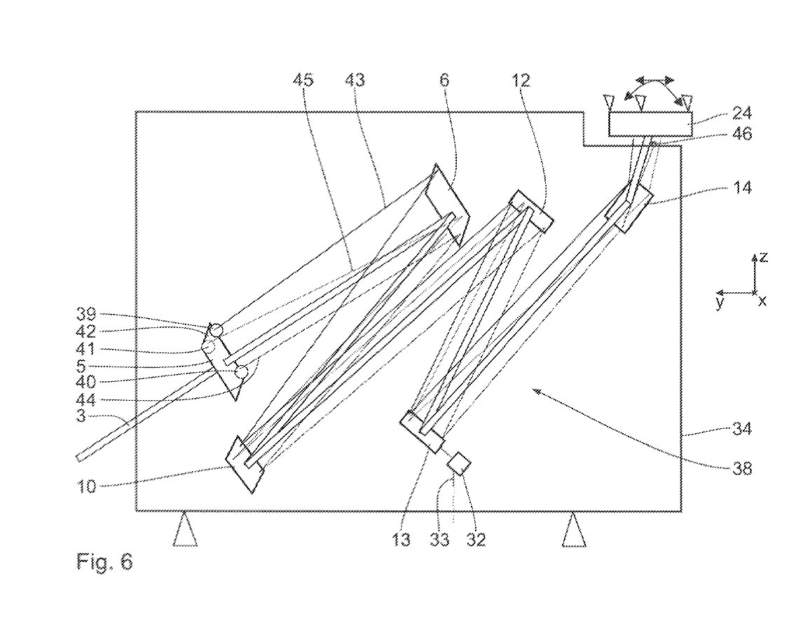

FIG. 6 shows a further design of an illumination optics 38 that can be used in the projection exposure machine 1 according to FIG. 1. Components that correspond to those which have already been explained above with reference to FIGS. 1 to 5 bear the same reference numerals and are not explained again in detail.

A used radiation beam 3 is illustrated extremely schematically in FIG. 6. Mirrors 6, 10 and 12 to 14 are also illustrated extremely schematically as regards the shape of their reflecting optical surfaces.

Three adjustment lasers 39 to 41 of an adjustment laser unit 42 are arranged in the region of the intermediate focal plane 5. Adjustment radiation beams 43, 44, 45 of the adjustment lasers 39 to 41 run adjacent to the optical path of the used light radiation beam 3 in such a way that the used light radiation beam 3 runs between the three adjustment radiation beams 43 to 45 through the mirrors 6, 10, 12, 13 and 14 of the illumination optics 38. After reflection at the mirror 14 the adjustment radiation beams 43 fall onto three assigned detectors with spatial resolution, of which one detector 46 is illustrated in FIG. 6 by way of example. These detectors are rigidly connected to the support frame 34. The position of the used radiation beam 3 can be inferred from the position of the three adjustment radiation beams 43 to 45 after reflection at the mirrors 6, 10, 12 to 14 of the illumination optics 38. Use may be made here of measurement methods that are comparable to those which are described in DE 10 2005 062 038 A1.

Depending on the measurement result of the detectors 46, which are connected for signaling purposes to the evaluation device 31 in a way not shown in more detail, the actuator 32 is, in turn, driven to displace the mirror 13 within six degrees of freedom in order to correct the optical path of the used radiation beam 3. It is ensured in this way that a preset tolerance is not exceeded by a relative displacement of the used radiation beam 3 in relation to the field intensity preset device 24, on the one hand, and by the used radiation beam 3 in relation to the reticle 18, on the other hand. This maximum displacement is to be ensured during a continuous illumination of the object, that is to say of the reticle 18. A larger displacement is tolerable during pauses in illumination, for example, between individual illuminations of various structured sections on the reticle 18.

As illustrated in FIG. 6, as an alternative to one or more adjustment radiation beams, it is also possible to make use for adjustment purposes, in accordance with the adjustment radiation beams, of a light wavelength that is carried with the used radiation beam 3, is not used in the projection exposure and differs from the used light wavelength. What is involved here can be, for example, a pump light or pump radiation wavelength for producing the EUV used radiation beam. The pump light can have a wavelength of 10 μm, for example. This light also carried can run on the same tracks that have been assigned above to the adjustment radiation beams 43 to 45 in the context of FIG. 6.

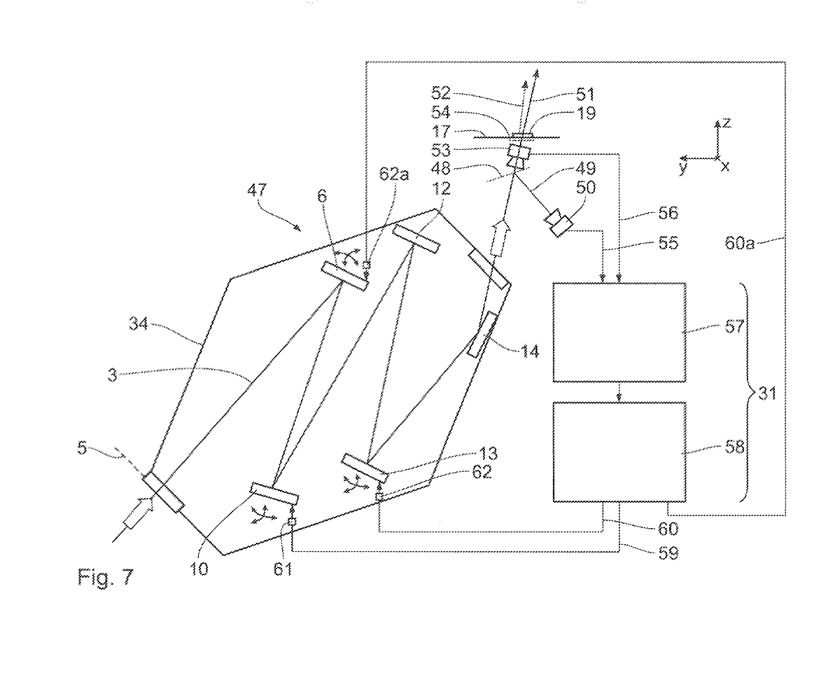

FIG. 7 shows a further design of an illumination optics 47 for use in the projection exposure machine 1. Components that correspond to those which have already been explained above with reference to FIGS. 1 to 6 bear the same reference numerals and are not explained again in detail.

A decoupling element 48 in the form of a mirror that is partially transparent to the used radiation is arranged upstream of the reticle plane 17 in the beam path of the used radiation beam 3 downstream of the EUV mirror 14.

A decoupled beam 49 reflected by the decoupling element 48 corresponds exactly with regard to its intensity distribution and beam angular distribution to the used radiation beam 3 downstream of the decoupling element 48. The decoupled beam 49 is measured with spatial resolution by a detector 50, which is a field direction sensor. The field direction sensor 50 can be used to detect the deviation of an actual beam direction of the used radiation beam 3, which is illustrated as a continuous line in FIG. 7, in the region of the reticle plane 17, from a desired beam direction 52 illustrated with dashes in FIG. 7.

Arranged downstream of the decoupling element 48 in the beam path of the used radiation beam 3 is a further detector 53 which measures with spatial resolution and is a field position sensor. Like the detector 28 of the design according to FIG. 4, the detector 53 can be inserted into the beam path of the used radiation beam 3 in the exposure pauses of the projection exposure machine 1. A deviation from an actual position of the object field 19 that is illustrated by a continuous line in FIG. 7 from a desired object field position 54 illustrated by dashes in FIG. 7 with the aid of the detector 53.

The refinement of the decoupling element 48 depends on the wavelength used by the detectors 50, 53. The decoupling element can be, for example, a mirror that is very small by comparison with the cross section of the used light beam 3 and decouples only a small portion of the used light beam 3. At other wavelengths that are used by the detectors 50, 53, the decoupling element 48 can also be a mirror with a coating that is reflective to the used wavelength of the field direction sensor 50 and transmissive to the used wavelength of the field position sensor 53. It is possible, in particular, for the decoupling element 48 also to be a 50-50 beam splitter with reference to the used wavelength of the detectors 50, 53. The beam splitter can then cover the entire component of the used light beam 3 that is used by the field position sensor 53.

The two detectors 50, 53 are arranged on planes of the optical illumination geometry which are not mutually optically conjugate. By way of example, it is possible in this way to extract a change in the position of the object field 19, on the one hand, and to extract a change in the direction of the used beam 3, on the other hand, via a linear combination of the measurement results of the two detectors 50, 53.

The detectors 50, 53 are connected for signaling purposes to an evaluation system 57 of the evaluation device 31 via signal lines 55, 56. A drive electronics 58 also belongs to the evaluation device 31 of the design according to FIG. 7. The drive electronics 58 is connected for signaling purposes to actuators 61, 62, 62a via signal lines 59, 60, 60a. The actuator 61 is mechanically connected to the field facet mirror 6. The actuator 62 is mechanically connected to the mirror 13. The actuator 62a is mechanically connected to the mirror 6. The mirrors 10, 13, 16 can respectively be displaced within six degrees of freedom via the actuators 61, 62, 62a. This is indicated in FIG. 7 schematically by double arrows next to the mirrors 6, 10 and 13, which are intended to illustrate the tilting degrees of freedom.

An adjustment of the mirrors via the actuators 32 or 61, 62, 62a for all six degrees of freedom is not mandatory. The mirrors that can be displaced by an actuator can also be displaced by fewer degrees of freedom, for example, by one degree of freedom, by two degrees of freedom, by three degrees of freedom, by four degrees of freedom or by five degrees of freedom.

For the purpose of exactly adjusting the used radiation beam 3, it suffices when exactly two of the three mirrors 6, 10, 13 can be displaced by an actuator. An exact adjustment of the used radiation beam 3 therefore can be achieved when the mirrors 6 and 10 or the mirrors 6 and 13 or the mirrors 10 and 13 can be adjusted by an actuator.

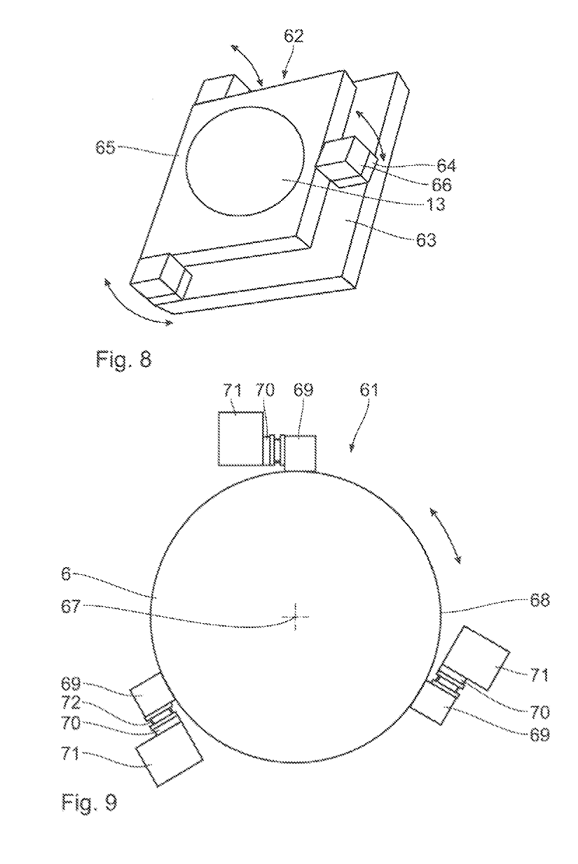

FIG. 8 shows an example of an actuator 62 for displacing the mirror 13 by three degrees of freedom. The actuator 62 includes a frame plate 63 that is rigidly connected to the support frame 34. A mirror mounting plate 65 is supported on the frame plate 63 via a total of three piezoelectric actuators 64 that are arranged distributed round the circumferential surface of the mirror 13. Here, a force application point 66 is assigned to each of the piezoelectric actuators 64. The mirror 13 is held rigidly in the mirror mounting plate 65.

The actuator 62 can be used to tilt the mirror 13 by two degrees of freedom and, when all three piezoelectric actuators 64 are driven simultaneously in the same way, to translate the mirror 13 perpendicular to its optical surface, that is to say to displace it by a third degree of freedom.

FIG. 9 shows an exemplary embodiment of a part of the actuator 61 with the aid of which the field facet mirror 6 can be rotated about a central axis 67 perpendicular to the optical surface of the field facet mirror 6. A mirror mounting plate 68 on which the field facet mirror 6 is rigidly held in a way not illustrated is supported on frame blocks 71, which are rigidly connected to the support frame 34, via three force application points 69 arranged distributed around the mirror mounting plate 68 in the circumferential direction and via piezoelectric actuators 70 respectively assigned to the force application points 69. Further respectively arranged between the piezoelectric actuators 70 and the force application points 69 is a solid joint 72 that ensures a compensation of tolerances between the piezoelectric actuator 70 and the force application point 62 in dependence on the absolute adjustment position of the mirror mounting plate 68 about the central axis 67.

A rotation of the field about the z-axis for correction purposes can be effected with the aid of the part of the actuator 61 illustrated in FIG. 9.

One of the piezoelectric actuators 64 and 70 can respectively have a stack composed of a plurality of stacked individual plates made from piezoelectrically active material, in order to enlarge the adjustment amplitude achievable via the piezoelectric actuator 64 and 70. Lorentz actuators can also be used instead of piezoelectric actuators 64, 70. Such actuators are known, for example, from U.S. Pat. No. 7,154,269 B2.

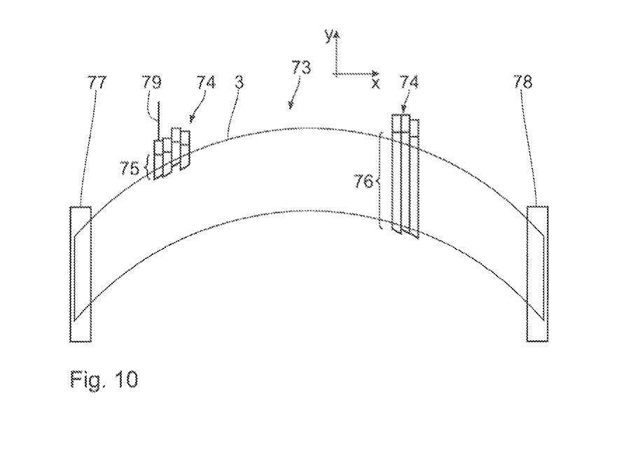

FIG. 10 shows a further design of a field intensity preset device 73 that can be used instead of the field intensity preset device 24.

Individual diaphragms 74 of the field intensity preset device 73, of which only a few representative individual diaphragms 74 are illustrated in FIG. 10, have at their end facing the used radiation beam 3 a measurement section 75 or 76 that is sensitive to the used radiation or, alternatively, to the adjustment radiation, or else to radiation that is also carried with the used light. Two designs of individual diaphragms 74 are possible here. In the case of the four individual diaphragms illustrated on the left in FIG. 10, the measurement section 75 is relatively short and constitutes a free end section of the respective individual diaphragm 74. In the case of the three individual diaphragms 74 illustrated on the right in FIG. 10, the measurement section 76 is longer than the associated dimension of the used radiation beam 3 along the scanning direction y. FIG. 10 shows the individual diaphragms 74 with the measurement sections 76 in a position moved completely into the used light beam 3 and in which the measurement sections 76 fully detect the used light beam 3 in the x-section respectively assigned to the individual diaphragm 7.

The measurement sections 75, 76 of the individual diaphragms 74 are connected for signaling purposes to the evaluation device 31 (not illustrated in FIG. 10) via signal lines 79, of which one signal line is illustrated in FIG. 10.

The individual diaphragms 74 with the measurement sections 75 are illustrated in a relative position which serves to homogenize the intensity distribution of the illumination of the object field 19 and in which the individual diaphragms 74, and thus the measurement sections 75, are moved into the used light beam 3 by different amounts. The measurement sections 75 are used to measure a radiant energy that is absorbed by the respective measurement section 75 and is correlated with the radiant energy of the used light.

The measurement sections 75, 76 can be thermal detectors with the aid of which it is possible to measure without spatial resolution an integrated absorbed energy of the radiation impinging on the measurement sections 75, 76. The measurement sections 75, 76 can also be designed as detectors that measure with spatial resolution.

Present at both edges of the used radiation beam 3 in a fashion perpendicular to the scan direction y and at the level of the field intensity preset device 73 are two detectors 77, 78 for measuring the position of the used radiation beam 3, and thus the position of the object field 19, that is to say the actual object field position. The detectors 77, 78 are CCD detectors that measure with spatial resolution and are sensitive to the used light or, alternatively, to adjustment light or to light carried with the used light.

The field intensity preset device 73 can be used, on the one hand, to determine the position of the used radiation beam 3 and, on the other hand, to correct the intensity distribution of the illumination of the object field 19 by the used radiation beam 3. The result of the measurement of the detectors 77, 78 and optionally the result of a measurement of the measurement sections 76 when fully moved in an illumination pause of the projection exposure machine 1 are used for the position determination. The measurement result of the measurement section 75 or of the guiding regions of the measurement section 76 is used to correct the intensity distribution of the object field illumination. If the absorbed energy detected in this measurement mode on one of the measurement sections 75, 76 drops, the respective individual diaphragm 74 is then inserted further into the beam path of the used radiation beam 3. If the measured power on the measurement sections 75, 76 rises in this measurement mode, the corresponding individual diaphragm 74 is withdrawn from the beam path of the used radiation beam 3.

In addition to the detectors described, the projection exposure machine 1 also further has a detector for measuring the total energy of used radiation output by the light source 2.

To the extent that the energy measured with the aid of the measurement sections 75, 76 falls or rises on all measurement sections 75, 76, the detector for the total energy of the light source 2 can be used to determine, by comparison, whether there is a drift of the total energy of the light source or a displacement of the used radiation beam 3 relative to all the individual diaphragms 74.

A measured change in position of the used radiation beam 3 relative to the individual diaphragms 74 and/or relative to the detectors 77, 78, and thus a corresponding change in position of the object field 19 can be corrected by appropriately driving a mirror, which corrects this position, via the drive electronics 58 of the evaluation device 31.

The illustrated embodiments of the illumination optics can also be used to correct the angular distribution of the illumination of the object field 19. For example, it is possible for this purpose for the illumination optics 26 to have in a pupil plane 80 (compare FIG. 1) an adjustable diaphragm arrangement with the aid of which specific pupil facets 11 can be compartmentalized, and thus the illumination angular distribution can be influenced. This diaphragm arrangement can, in turn, be driven by the drive electronics 58 as a function of the result of appropriate detector measurements.

A correction of illumination parameters, that is to say of the intensity distribution of the object field illumination and/or of the angular distribution of the object field illumination with the aid of the illumination optics 26, 38 or 47, takes place as follows: the detectors or measurement sections 28, 46, 50, 53, 75, 76, 77, 78 are used to detect the position of the used radiation beam 3 and, if appropriate, the intensity distribution thereof and the illumination angular distribution thereof. The detector measured data are then evaluated by the evaluation system 57 of the evaluation device 31, and converted in the drive electronics 58 into control signals for the actuators 32, 64, 70 or the drives for the individual diaphragms 27 or 74. These components are then displaced through being appropriately driven such that an actual value of the illumination parameters of the intensity distribution of the object field illumination or angular distribution of the object field illumination corresponds to a desired value within a preset tolerance band. This correction is performed with the aid of a time constant in the region of 5 ms so that the correction is still effective during a scanning exposure.

In principle, the field intensity preset devices 24 and 73 can also be arranged in a field plane of the respective illumination optics that is conjugate to the field plane 16.

In the case of the illumination optics 26, 38, 47, exactly two displaceable correction mirrors can be used, for example, the mirror pair of field facet mirror 6/pupil facet mirror 10, the mirror pair of field facet mirror 6/mirror 13, or the mirror pair of pupil facet mirror 10/mirror 13. Such a displaceable mirror pair in principle provides the possibility of correcting both the intensity distribution of the object field illumination, and the angular distribution of the object field illumination.

The evaluation device 31 can be connected for signaling purposes to a control device 81 for the light source 2 (compare FIG. 1). It is possible in this way for the evaluation device 31 also to take account during the correction of parameter changes in the light source 2 that are made available to the evaluation device 31 via the control device of the light source 2, for example, on the basis of manipulating variables of actuators of the light source 2, or on the basis of detector measurements by detectors of the light source 2.

What is claimed is:

1. An illumination optics configured to illuminate an object in an object field with an EUV used radiation beam, the illumination optics comprising:
an illumination intensity preset device configured to illuminate the object field with an intensity distribution;
an illumination angle preset device configured to illuminate the object field with an angle distribution; and
an illumination correction device configured to correct at least one parameter selected from the group consisting of the intensity distribution of the object field and the angle distribution of the object field, the illumination correction device comprising:
a diaphragm arrangement in a region of a plane selected from the group consisting of an object field plane of the illumination optics and a plane conjugate to an object the object field plane of the illumination optics, the diaphragm arrangement comprising a plurality of finger diaphragms displaceable along a displacement direction along which the object is displaced during a projection exposure;
a detector configured to measure a position of the EUV used radiation beam in the region of the object field;
an evaluation device in signal communication with the detector, the evaluation device configured to evaluate data from the detector and to convert the detector data into control signals; and
an actuator in signal communication with the evaluation device, the actuator configured to vary a relative position between the EUV used radiation beam and the diaphragm arrangement,
wherein:
the illumination correction device is configured so that, during an illumination period, edges of the used radiation beam have a maximum displacement toward the finger diaphragms in a direction perpendicular to a beam direction of the used radiation beam;
the maximum displacement is 8 μm; and
the illumination optics is an EUV microlithography illumination optics.

2. The illumination optics of claim 1, wherein the actuator is configured to effect a displacement of the diaphragm arrangement to vary the relative position between the EUV used radiation beam and the diaphragm arrangement.

3. The illumination optics of claim 1, wherein the detector is disposed at an end of a finger diaphragm facing the used radiation beam.

4. The illumination optics of claim 1, wherein the finger diaphragms are adjacent to one another and transverse to the displacement direction so that, in their totality, the finger diaphragms entirely cover an object field dimension transverse to the displacement direction.

5. The illumination optics of claim 1, comprising an EUV correction mirror, wherein the actuator effects a displacement of the EUV correction mirror to vary the relative position between the EUV used radiation beam and the diaphragm arrangement.

6. The illumination optics of claim 5, wherein the EUV correction mirror is configured to be displaced in at least two degrees of freedom.

7. The illumination optics of claim 5, wherein the EUV correction mirror is displaceable via at least two actuators.

8. The illumination optics of claim 7, wherein the at least two actuators comprise at least two piezoactuators or at least two Lorentz actuators.

9. The illumination optics of claim 7, wherein one of the at least two actuators comprises a piezoactuator, and the piezoactuator comprises a plurality of stacked individual plates comprising a piezoelectrically active material.

10. The illumination optics of claim 5, wherein three actuators are distributed in a circumferential direction relative to the EUV correction mirror, and the three actuators are configured to pivot the EUV correction mirror about an axis perpendicular to an optical surface of the EUV correction mirror.

11. The illumination optics of claim 1, comprising exactly two EUV correction mirrors displaceable by at least two degrees of freedom.

12. The illumination optics of claim 1, wherein the illumination correction device comprises a pupil facet mirror.

13. The illumination optics of claim 1, comprising an EUV mirror downstream of the illumination intensity preset device and the illumination angle preset device, wherein the EUV mirror is upstream of the object field, and the EUV mirror is an EUV correction mirror.

14. The illumination optics of claim 1, wherein the illumination correction device is configured so that the illumination parameter is corrected via a time constant in a region of 5 milliseconds as measured from an acquisition of an illumination actual value by the detector up to a driven displacement of the actuator.

15. The illumination optics of claim 1, wherein the illumination correction device comprises an adjustment light source configured to provide an adjustment radiation beam which is guided on a path that coincides with the path of the used radiation beam or that is closely adjacent thereto, and wherein the detector is sensitive to the adjustment radiation beam.

16. The illumination optics of claim 1, wherein the detector is sensitive to a wavelength of the used radiation beam, and the light detector is sensitive to light wavelengths which differ from the wavelength of the used radiation beam.

17. The illumination optics of claim 1, wherein the detector is configured to measure with spatial resolution and to acquire at least one section of a measuring light beam.

18. The illumination optics of claim 1, comprising two detectors arranged in planes which are not mutually optically conjugate.

19. The illumination optics of claim 1, wherein the detector is configured to acquire with spatial resolution an edge-side section transverse to the displacement direction of the used radiation beam along an entire extent of the displacement direction of the used radiation beam.

20. The illumination optics of claim 1, wherein the detector is a thermal detector.

21. An illumination system, comprising:
an EUV light source; and
an illumination optics according to claim 1.

22. The illumination system of claim 21, wherein the illumination optics and the light source are rigidly fixed on a common support frame.

23. The illumination system of claim 21, further comprising a control device of the light source, wherein the evaluation device is in signal communication with the control device of the light source.

24. A machine, comprising:
an illumination system comprising an illumination optics according to claim 1,
wherein the machine is a microlithography projection exposure machine.

25. An illumination optics configured to illuminate an object field with an EUV used radiation beam, the illumination optics comprising:
an illumination intensity preset device configured to illuminate the object field with an intensity distribution;
an illumination angle preset device configured to illuminate the object field with an illumination angle distribution; and
an illumination correction device configured to correct at least one parameter selected from the group consisting of the intensity distribution of the object field illumination and the angular distribution of the object field illumination, the illumination correction device comprising:
a detector configured to measure a position of the EUV used radiation beam in a region of the object field;
an evaluation device in signal communication with the detector, the evaluation device configured to evaluate detector data and to convert the detector data into control signals; and
an actuator in signal communication with the evaluation device, the actuator configured to displace an EUV correction mirror to vary a position of the EUV used radiation beam in the region of the object field,
wherein:
the illumination correction device is configured so that, during an illumination period, edges of the used radiation beam have a maximum displacement toward the finger diaphragms in a direction perpendicular to a beam direction of the used radiation beam;
the maximum displacement is 8 μm; and
the illumination optics is an EUV microlithography illumination optics.

26. The illumination optics of claim 25, wherein at least one member selected from the group consisting of the illumination intensity preset device and the illumination angle preset device comprises the EUV correction mirror.
